(19) United States
(12) Patent Application Publication
(10) Pub. No.: US 2015/0355309 A1
(43) Pub. Date: Dec. 10, 2015

(54) TARGET TRACKING IMPLEMENTING CONCENTRIC RINGLETS ASSOCIATED WITH TARGET FEATURES

(71) Applicant: University of Dayton, Dayton, OH (US)

(72) Inventors: Theus Aspiras, Kettering, OH (US); Vijayan K. Asari, Dayton, OH (US)

(21) Appl. No.: 14/731,838

(22) Filed: Jun. 5, 2015

Related U.S. Application Data
(60) Provisional application No. 62/008,231, filed on Jun. 5, 2014.

(51) Int. Cl. G01S 3/786

(52) U.S. Cl. CPC G01S 3/7864

(57) ABSTRACT

Systems, methods, and computer product for identifying and tracking an object of interest from an image capturing system based on a plurality of features associated with the object of interest. The object of interest may be tracked based on features associated with the object of interest. A center feature associated with the object of interest is designated. The center feature changes location as the object of interest changes location. A plurality of ringlets is generated. Each ringlet is concentrically positioned so that each ringlet encircles the center feature and encompasses additional features associated with the object of interest. The object of interest is tracked with feature data extracted by each ringlet as the object of interest changes location and/or orientation. The feature data is associated with each feature of the object of interest that each ringlet encompasses.

Pursuant to 37 C.F.R. §1.78(a)(4), this application claims the benefit of and priority to prior filed co-pending Provisional Application Ser. No. 62/008,231 filed Jun. 5, 2014, which is expressly incorporated herein by reference.

### BACKGROUND

The present invention relates to methods and systems for identifying and tracking an object of interest from an image capturing system.

Target tracking involves the tracking of a specified target based on image data captured by an imaging device. The imaging device follows the target and returns image data depicting the position of the target in real-time to a display for a user to observe. Often times, the target may disappear from the field of view of the imaging device due to an obstruction and then reappear. For example, the target enters a tunnel that is outside the field of view and then re-enters when the target departs from the tunnel.

After the imaging device temporarily loses sight of the target due to the obstruction, the imaging device may fail to track the target when the target reappears in the field of view of the imaging device. For example, the imaging device may mistakenly track another object that also returns into the field of view when the object is moving in a similar direction and velocity as the specified target that originally departed from the field of view. In another example, the imaging device may fail to track the specified target when the target reappears in the field of view but is heading in a different direction than when the target initially disappeared from the field of view. Thus, the imaging device no longer tracks the target when the target returns to the field of view.

Improved methods and systems are needed for identifying and tracking an object of interest from an image capturing system.

### SUMMARY

Embodiments of the invention relate to tracking an object of interest by associating a plurality of ringlets with the object of interest where the ringlets are concentrically positioned relative to the object of interest so that each ringlet encompasses a different feature for the object of interest. In an embodiment, a system identifies and tracks an object of interest from an image capturing system based on a plurality of features associated with the object of interest. The system includes a processor and memory coupled with the processor. The memory includes instructions that, when executed by the processor, causes the processor to identify the object of interest to be tracked based on a visible designation of the object of interest from image data captured by the image capturing system. The processor is configured to designate a center feature associated with the object of interest. The center feature changes location as the object of interest changes location. The processor is configured to generate a plurality of ringlets. Each ringlet is concentrically positioned so that each ringlet encircles the center feature and encompasses additional features associated with the object of interest. The processor is also configured to track the object of interest with feature data extracted by each ringlet as the object of interest changes location and/or orientation. The feature data is associated with each feature of the object of interest that each ringlet encompasses.

In an embodiment, a computer implemented method identifies and tracks an object of interest from an image capturing system based on a plurality of features associated with the object of interest. The object of interest to be tracked is identified by a processor based on a visible designation of the object of interest from image data captured by the image capturing system. A center feature associated with the object of interest is designated by the processor. The center feature changes location as the object of interest changes location. A plurality of ringlets may be generated by the processor. Each ringlet is concentrically positioned so that each ringlet encircles the center feature and encompasses additional features associated with the object of interest. The object of interest is tracked by the processor with feature data extracted by each ringlet as the object of interest changes location and/or orientation. The feature data is associated with each feature of the object of interest that each ringlet encompasses.

In an embodiment, a non-transitory computer readable storage medium within a computer program where the program comprises instructions that when executed by one or more processors cause the one or more processors to perform operations to identify and track an object of interest from an image capturing system based on a plurality of features associated with the object of interest. The object of interest to be tracked is identified by a processor based on a visible designation of the object of interest from image data captured by the image capturing system. A center feature associated with the object of interest is designated by the processor. The center feature changes location as the object of interest changes location. A plurality of ringlets may be generated by the processor. Each ringlet is concentrically positioned so that each ringlet encircles the center feature and encompasses additional features associated with the object of interest. The object of interest is tracked by the processor with feature data extracted by each ringlet as the object of interest changes location and/or orientation. The feature data is associated with each feature of the object of interest that each ringlet encompasses.

### BRIEF DESCRIPTION OF THE DRAWINGS/FIGURES

Embodiments are described with reference to the accompanying drawings. In the drawings, like reference numbers may indicate identical or functionally similar elements.

FIG. 1 is an illustration of a conventional target tracking configuration.

FIG. 2 is a detailed view of an exemplary target tracking configuration for tracking an object of interest based on features associated with the object of interest.

FIG. 3 is a detailed view of an exemplary ringlet configuration for tracking an object of interest based on features associated with the object of interest.

FIG. 4 is a detailed view of an exemplary Gaussian distribution generated by a ringlet configuration for tracking an object of interest based on features associated with the object of interest.

FIG. 5 is a flowchart showing an example method for identifying and tracking an object of interest from an image capturing system based on a plurality of features associated with the object of interest.

FIG. 6 is an example computer system in which embodiments of the invention, or portions thereof, may be implemented as computer-readable code.

### DETAILED DESCRIPTION

Embodiments of the invention generally relate to target tracking. In an example embodiment, an object of interest is identified based on a visible designation of the object of interest from image data captured by an imaging system. A center feature of the object of interest may then be designated. The center feature changes location as the object of interest changes location. For example, an airborne imaging system is tracking a vehicle located on the ground so the designated center feature is a center portion of the roof of the vehicle. Ringlets are then generated where the ringlets are concentrically positioned so that each ringlet encircles the center feature of the object of interest and also encompass additional features associated with the object of interest. For example, the smallest ringlet encompasses the center portion of the roof of the vehicle while each larger ringlet encompasses a different feature of the vehicle until the largest ringlet encompasses the edges of the vehicle while each ringlet encircles the center portion of the roof of the vehicle.

The object of interest is then tracked based on feature data extracted by each ringlet as the object of interest changes location and/or orientation. The feature data is associated with each feature of the object of interest that each ringlet encompasses. The feature data extracted by each ringlet prevents the image capturing system from mistakenly tracking an incorrect object when the object of interest disappears from the field of view of the image capturing system due to an obstruction and then reappears. For example, the vehicle may enter a tunnel so that the vehicle disappears from the field of view of the image capturing system. The feature data extracted by each ringlet is associated with features unique to the vehicle. As a result, the image capturing system refrains from tracking an incorrect vehicle that departs the tunnel with similar velocity and direction to the vehicle of interest that entered the tunnel.

The center feature of the object of interest has a low likelihood of rotating when the object of interest rotates. As a result, the smallest ringlet that encompasses the center feature of the object of interest is likely to generate feature data that is substantially rotationally invariant so that the image capturing system tracks the object of interest when the object of interest reappears in the field of view of the image capturing system but is traveling in a different direction than when the object of interest disappeared from the field of view. For example, the smallest ringlet may be associated with the center portion of the roof of the vehicle. The vehicle may depart the tunnel and turn to travel in a different direction than when the vehicle entered the tunnel. However, the center portion of the roof of the vehicle may fail to rotate as compared to the edges of the vehicle as the vehicle executes the turn when departing the tunnel. As a result, feature data extracted by the smallest ringlet when the vehicle changes direction when departing the tunnel may be substantially similar to the feature data extracted by the smallest ringlet when the vehicle initially entered the tunnel.

In the Detailed Description herein, references to “one embodiment”, “an embodiment”, an “example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in the art to affect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

### Overview

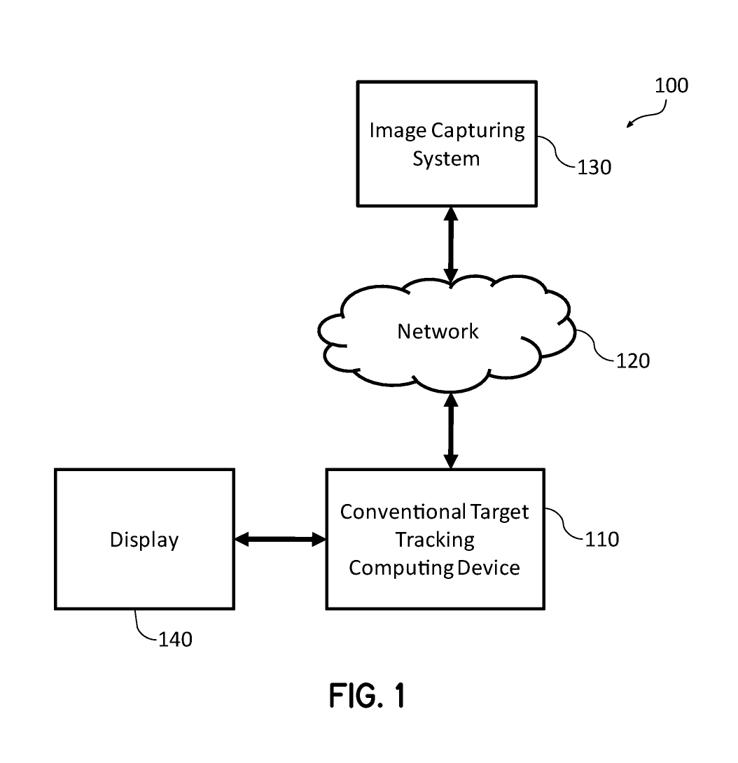

FIG. 1 shows an illustration of a conventional target tracking configuration 100. Conventional target tracking configuration 100 includes a conventional target tracking computing device 110, a network 120, an image capturing system 130, and a display 140.

One or more image capturing systems 130 may connect to one or more conventional target tracking computing devices 110 via network 120. Image capturing system 130 may include a data acquisition system, a data management system, intranet, conventional web server, e-mail server, or file transfer server modified according to one embodiment. Image capturing system 130 is typically a device that includes a processor, a memory, and a network interface, hereinafter referred to as a computing device or simply “computer.”

Image capturing system 130 may include one or more imaging devices that capture image data. Image capturing system 130 may also include a video imaging system, an infrared imaging system, a photographic imaging system and/or any other type of image capturing system that includes imaging devices. Image data is data captured by the pixels of image capturing system 130 that depicts visible characteristics of objects that are represented in the images captured by image capturing system 130. Image capturing system 130 may also include tracking capabilities. Image capturing system 130 may be able to detect any movement by an object of interest and then track the object of interest as the object moves. For example, image capturing system 130 may detect a car that has been designated as an object of interest and then may track the movement of the car. The object of interest may be a moveable object where the changing location of the object is of interest to a user where the user requests to track the movement of the object. The object of interest may satisfy programmable criteria that specify the features that designate what type of object is to be tracked.

Image capturing system 130 may be coupled to a stationary and/or moveable platform. Image capturing system 130 may be coupled to a stationary platform positioned on the ground so that image capturing system 130 may capture image data depicting objects of interest that are airborne and within a static field of view of image capturing system 130 that remains unchanged as image capturing system 130 remains stationary. The field of view of image capturing system 130 is the range in which image capturing system 130 captures image data. Image capturing system 130 may not capture image data of any object of interest that is outside of the field of view of image capturing system 130. Image capturing system 130 may also be coupled to moveable platforms positioned on the ground and/or in the air so that image capturing system 130 may capture image data depicting objects of interest that are airborne and/or on the ground. Image capturing system 130 when coupled to a moveable platform includes a dynamic field of view that changes as the moveable platform changes location. For example, image capturing system 130 may be coupled to an airborne moveable platform that includes but is not limited to an airplane, a helicopter, an unmanned aerial vehicle (UAV), a remotely piloted aircraft (RPA), a satellite, and/or any other type of vehicle used to gather image data of an object of interest.

In an embodiment, image capturing system 130 may stream the captured image data to conventional target tracking computing device 110 via network 120. Network 120 includes one or more networks, such as the Internet. In some embodiments of the present invention, network 120 may include one or more wide area networks (WAN) or local area networks (LAN). Network 120 may utilize one or more network technologies such as Ethernet, Fast Ethernet, Gigabit Ethernet, virtual private network (VPN), remote VPN access, a variant of IEEE 802.11 standard such as Wi-Fi, and the like. Communication over network 120 takes place using one or more network communication protocols including reliable streaming protocols such as transmission control protocol (TCP). In another embodiment, image capturing system 130 may stream the captured image data directly to conventional target tracking computing device 110 via a wired connection such as, but not limited to, a fiber optic connection, a coaxial cable connection, a copper cable connection, and/or any other direct wired connection.

Conventional target tracking computing device 110 may be any type of processing (or computing device) as described above. For example, conventional target tracking computing device 110 may be a workstation, mobile device, computer, cluster of computers, set-top box, or other computing device. In an embodiment, multiple modules may be implemented on the same computing device. Such a computing device may include software, firmware, hardware, or a combination thereof. Software may include one or more application on an operating system. Hardware can include, but is not limited to, a processor, memory, and/or graphical user interface display.

Conventional target tracking computing device 110 may also include a conventional web server, e-mail server, or file transfer server configured to provide functions of the various embodiments of the invention.

Conventional target tracking computing device 110 may track the object of interest while displaying the tracking of the object of interest via display 140. Display 140 can be any type of display device including but not limited to a touch screen display, a cathode ray tube (CRT) monitor, a liquid crystal display (LCD) screen, and/or any other type of display.

Conventional target tracking computing device 110 tracks the object of interest using a grid-based methodology. Conventional target tracking computing device 110 overlays the field of view of image capturing system 130 with a rectangular grid. Conventional target tracking computing device 110 identifies the object of interest to track based on the velocity and direction of the object of interest. The initial velocity and direction parameters of the object of interest are first identified by the first rectangle included in the rectangular grid that conventional target tracking computing device 110 begins tracking the object of interest.

The first rectangle extracts data associated with the velocity and direction of the object of interest and conventional target tracking computing device 110 tracks the object of interest based on the velocity and direction data extracted by each rectangle included in each rectangular grid. Conventional target tracking computing device 110 identifies as the velocity and direction of the object of interest varies as the object of interest departs and/or enters each rectangle included in the rectangular grid. As the object of interest departs each rectangle, the rectangle extracts the velocity and direction data of the object of interest. Then conventional target tracking computing device 110 searches for similar velocity and direction data to be provided by a rectangle contiguous to the previous rectangle as the object of interest enters the contiguous rectangle. Conventional target tracking computing device 110 then continues to track the object of interest based on the similar velocity and direction data extracted by the rectangle.

However, the rectangular grid fails to extract data associated with the specified velocity and direction parameters when the object of interest temporarily disappears from the field of view of image capturing system 130. For example, the rectangular grid fails to extract data from the object of interest when the object of interest enters a tunnel and temporarily disappears from the field of view of image capturing system 130. As the object of interest departs the rectangle included in the rectangular grid and enters the tunnel, the rectangle extracts the velocity and direction data associated with the object of interest. Conventional target computing device 110 then searches for similar velocity and direction data to be extracted by the rectangles that the object of interest may enter when departing the tunnel and then reappearing in the field of view of image capturing system 130. Once a rectangle extracts similar velocity and direction data to that of when the object of interest departed the field of view, conventional target computing device 110 then begins to track the object associated with the similar velocity and direction data.

However, another object different from the object of interest may depart from the tunnel and reappear in the field of view of image capturing system 130 before the object of interest. The object may travel at a velocity and in a direction similar to that of the object of interest when the object of interest initially departed the field of view and entered the tunnel. As a result, the rectangle included in the rectangular grid then extracts the velocity and direction data associated with the other object that is similar to that of the object of interest as the object reappears in the field of view before the object of interest. Conventional target computing device 110 then mistakenly begins to track the object based on the similar velocity and direction data extracted by the rectangle and no longer tracks the object of interest.

Conventional target tracking computing device 110 also tracks the object of interest using a feature-based methodology. Conventional target tracking computing device 110 overlays the object of interest with a square where the square encompasses portions of the object of interest as the object of interest maneuvers about the field of view of image capturing system 130. Conventional target tracking computing device 110 identifies the object of interest to track based on the edge features of the object of interest. The edge features of the object of interest are portions of the object of interest associated with the edges of the object of interest. For example, the edge features of a vehicle may include the front bumper, the rear bumper, the driver side doors, and the passenger side doors of the vehicle. The edge features of the object of interest may be extracted by the portions of the perimeter of the square overlaid on the object of interest that encompasses portions of the edge features of the object of interest.

Typically, the square overlaid on the object of interest fails to completely encompass the edges of the object of interest for the entire period of time that the object of interest is within the field of view of image capturing system 130. Rather, different portions of the edges of the object of interest are extracted by the square overlaid on the object of interest as the object of interest maneuvers throughout the field of view. Each pixel in the field of view of image capturing system 130 is associated with an edge feature of the object of interest. Portions of the square that encompass portions of the object of interest then extract the edge feature data from the pixels associated with each edge feature of the object of interest that is encompassed by the portions of the square overlaid on the object of interest.

For example, the object of interest may be a car so that the edge features include the front bumper, back bumper, the driver side doors and the passenger side doors of the car so that portions of the perimeter of the car are encompassed by portions of the perimeter of the square overlaid on the object of interest. A first pixel may be associated with the front bumper of the car and a first corner of the square extracts edge feature data associated with the front bumper of the car from the first pixel as the front bumper of the car maneuvers throughout the field of view of image capturing system 130. As the edge features of the object of interest encompassed by portions of the square move about the field of view, conventional target tracking computing device 110 tracks the object of interest based on the edge feature data extracted by the first corner of the square that encompasses the front edge of the car.

However, the square overlaid on the object of interest fails to extract any edge feature data when the object of interest temporarily disappears from the field of view of image capturing system 130 and then when reappearing in the field of view is traveling in a direction different than when the object of interest initially disappeared from the field of view. For example, the first corner of the square that encompasses the front bumper of the car is associated with the first pixel in the field of view of image capturing system 130 when the object of interest enters a tunnel and disappears from the field of view of image capturing system 130. Conventional target tracking computing device 110 expects to identify front bumper feature data extracted by the first corner of the square after the car departs the tunnel and reappears in the field of view that is similar to the front bumper data extracted by the first corner of the square when the car initially entered the tunnel and disappeared from the field of view.

However, the front bumper of the car is associated with a different pixel when the car is traveling in a different direction after the car departs the tunnel as compared to before the car entered the tunnel. The front bumper feature data extracted by the first corner of the square when the car departs the tunnel is different from when the car entered the tunnel. Conventional target computing device 110 then continues to wait for front bumper feature data associated with the front bumper of the car that is similar to the front bumper feature data extracted by the first corner of the square when the car entered the tunnel. However, the car has already departed the tunnel and is traveling in a different direction. Because the front bumper of the car is associated with a different pixel after changing direction, conventional target tracking computing device 110 fails to recognize that the car has changed direction and fails to continue to track the car. Rather, conventional target tracking computing device 110 continues to wait to receive front bumper feature data that is associated with the front bumper of the car that is traveling in the same direction as when the car entered the tunnel.

Conventional target tracking computing device 110 also implements a binary binning methodology in determining which pixels in the field of view of image capturing system 130 are to be used to extract data associated with those pixels relative to the object of interest. Conventional target tracking computing device 110 assigns a “1” to each pixel that is encompassed by the edges of the square that is overlaid on the object of interest in the field of view. Conventional target tracking computing device 110 implements the data associated with each pixel that is assigned a “1” in tracking the object of interest. Conventional target tracking computing device 110 then assigns a “0” to each pixel that is not encompassed by the edges of the square that is overlaid on the object of interest. Conventional target tracking computing device 110 disregards the data associated with each pixel that is assigned a “0” in tracking the object of interest.

However, the edges of the square that is overlaid on the object of interest do not completely encompass the edges of the object of interest. As the object of interest maneuvers throughout the field of view of image capturing system 130, portions of the object of interest extend beyond the edges of the square overlaid on the object of interest. Conventional target tracking computing device 110 assigns a “0” to each pixel associated with portions of the object of interest that fall outside of the edges of the square overlaid on the object of interest. As a result, conventional target tracking computing device 110 disregards any data associated with pixels that are outside of the square that is overlaid on the object of interest despite those pixels being associated with portions of the object of interest.

Such a disregard of data that is associated with the object of interest hinders the ability of conventional target tracking computing device 110 to adequately track the object of interest. Particularly in applications where image capturing system 130 extracts wide area imagery with low resolution, the features associated with the object of interest are not well defined, which increases the difficulty for conventional target tracking computing device 110 to adequately target the object of interest. The low resolution results in a decrease in the data that the square overlaid on the object of interest is able to obtain so that conventional target tracking computing device 110 has less data with which to track the object of interest. Automatically discarding data associated with the object of interest, particularly the edges of the object of interest that define the outer bounds of the object of interest relative to the scene, hinders the ability of conventional target tracking computing device to adequately track the object of interest. The scene includes the data associated with all objects included in the field of view of image capturing system 130 that is excluded for the object of interest. For example, the scene includes data associated with roads, buildings, trees, and so on that image capturing system 130 also captures when tracking the object of interest.

### Target Tracking

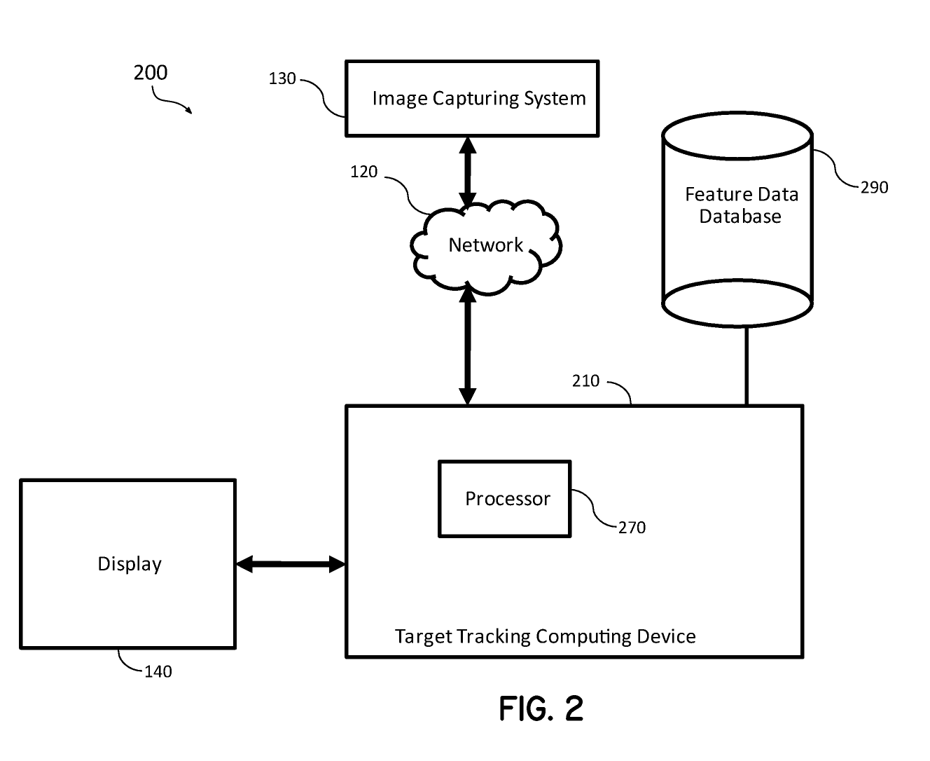

FIG. 2 depicts a detailed view of an exemplary target tracking configuration 200 for tracking an object of interest based on features associated with the object of interest. Target tracking configuration 200 includes image capturing system 130, network 120, display 140, a target tracking computing device 210, and a feature data database 290. Target tracking computing device 210 includes a processor 270.

Target tracking computing device 210 may track the object of interest based on feature data extracted by a plurality of ringlets associated with the object of interest. Target tracking computing device 210 may overlay the ringlets onto the object of interest so that each ringlet is concentrically positioned relative to each other so that each ringlet encompasses different features associated with the object of interest. For example, the ringlet with the smallest radius may be positioned over a center of the object of interest and then each other ringlet may be concentrically positioned over the object of interest so that the ringlet with the largest radius encompasses the edges of the object of interest. Feature data is then extracted by each ringlet as the object of interest maneuvers throughout the field of view of image capturing system 130. The feature data extracted by the ringlet with the smallest diameter and encompassing the center of the object of interest may remain substantially the same despite the object of interest changing direction so that such feature data is rotationally invariant.

Target tracking computing device 210 may then weight the feature data where the feature data extracted by the ringlets that extract feature data that are rotationally invariant so that these ringlets are given the greatest weight and the feature data extracted by ringlets with larger radii that extract feature data that are not rotationally invariant are given the least amount of weight. Target tracking computing device 210 weights the feature data using a Gaussian distribution so that each feature data is incorporated into the tracking of the object of interest. Target tracking computing device 210 may then compare the weighted feature data to feature data already stored in feature data database 290. Target tracking computing device 210 may continue to track the object of interest when the feature data is within a threshold of the stored feature data.

Target tracking computing device 210 may be any type of processing (or computing device) as described above. For example, target tracking computing device 210 may be a workstation, mobile device, computer, cluster of computers, set-top box, or other computing device. In an embodiment, multiple modules may be implemented on the same computing device. Such a computing device may include software, firmware, hardware, or a combination thereof. Software may include one or more application on an operating system. Hardware can include, but is not limited to, a processor, memory, and/or graphical user interface display.

Target tracking computing device 210 may also include a conventional web server, e-mail server, or file transfer server configured to provide functions of the various embodiments of the invention.

The actions associated with target tracking computing device 210 as described below may be executed by processor 270. Examples of functionality performed by processor 270 are referenced in the below discussion. However, the below references are examples and are not limiting. The functionality of processor 270 may be performed individually by processor 270 and/or be shared among any combination of processors 270. As referred to herein, processor 270 may be any type of processing (or computing) device having one or more processors. For example, processor 270 can be an individual processor, workstation, mobile device, computer, cluster of computers, set-top box, game console or other device having at least one processor. Processor 270 may include software, firmware, hardware, or a combination thereof. Software may include one or more applications and an operating system. Hardware can include, but may not be limited to, a processor, memory, and/or graphical user display.

Target tracking computing device 210, image capturing system 130 and feature data database 290 may share resources via network 120. For example, target tracking computing device 210 may retrieve stored feature data associated with the object of interest from feature data database 290. Image capturing system 130 may provide image data to feature data database 290 via network 120. Based on the cloud computing configuration, the interaction between target tracking computing device 210, image capturing system 130, and feature data database 290 may not be limited to a single computing device. For example, a plurality of computing devices may update feature data database 290 via network 120 with feature data associated with the object of interest.

As noted above, target tracking computing device 210 may track the object of interest based on the features associated with the object of interest. Features associated with the object of interest may be definitive aspects of the object of interest that are physically visible when image capturing system 130 captures image data of the object of interest. For example, as noted above, edge features of a vehicle may include the front bumper, the rear bumper, the driver side doors, and the passenger side doors of the vehicle. Other examples of features may include the center portion of the roof of the vehicle and/or a crane hook of a crane vehicle.

The tracking of the object of interest based on the features associated with the object of interest prevents target tracking computing device 210 from incorrectly tracking another object. The features tracked by target tracking computing device 210 are specific to the object of interest so the likelihood in target tracking computing device 210 incorrectly tracking another object is decreased.

For example, the object of interest may be a vehicle of interest that disappears from the field of view of image capturing system 130 when the vehicle of interest enters a tunnel. The vehicle of interest may include features unique to the vehicle of interest and enters the tunnel at a specific velocity and direction. Another vehicle with features that differ from the vehicle of interest may reappear in the field of view of image capturing system 130 before the vehicle of interest by departing the tunnel before the vehicle of interest. The vehicle may be traveling at a similar velocity and in a similar direction as the vehicle of interest was when entering the tunnel. Because target tracking computing device 210 tracks the features unique to the vehicle of interest rather than other parameters that may be replicated by other vehicles, such as direction and velocity, target tracking computing device 210 refrains from tracking the vehicle traveling at a similar velocity and direction as the vehicle of interest. Rather, target tracking computing device 210 searches for the features that are unique to the vehicle of interest and begins tracking the vehicle of interest when the vehicle of interest departs the tunnel.

As the object of interest maneuvers throughout the field of view of image capturing system 130, target tracking computing device 210 tracks the object of interest based on feature data generated from the particular features associated with the object of interest. Feature data generated by a particular feature may include but is not limited to a direction that the particular feature is moving within the field of view of image capturing system 130, a velocity that the particular feature is moving, spatial information of the particular feature where the spatial information defines where in the field of view of image capturing system 130 that the particular feature is located, intensity information of the particular feature where the intensity information represents a level of electromagnetic energy emitted by the particular feature, and/or any other feature data associated with the particular feature that may be captured by image capturing system 130 so that the feature may be tracked.

Image capturing system 130 may have a wide field of view where the range in which image capturing system 130 captures image data is increased so that image capturing system 130 captures a greater physical area of image data than when image capturing system 130 has a narrow field of view. Although image capturing system 130 captures a greater physical area of image data when operating with a wide field of view, the resolution of the image data typically is decreased so that the image data captures less detail of objects included in the wide field of view. For example, the feature data associated with the features of the object of interest may be less defined with the lower resolution associated with the wide field of view of image capturing system 130 increasing the difficulty to track the object of interest based on such feature data. The quality of resolution of image capturing system 130 may be based on the size of each pixel and the quantity of pixels included in the field of view of image capturing system 130. As the size of each pixel decreases which increases the quantity of pixels increases, the resolution of image capturing system 130 also increases. As the size of each pixel increases which decreases the quantity of pixels, the resolution of image capturing system 130 also decreases.

As a result, target tracking computing device 210 may track the object of interest based on the intensity information associated with the features of the object of interest when image capturing system 130 operates in the wide field of view. Despite the low resolution associated with the features of the object of interest in the wide field of view, the intensity information that represents the level of electromagnetic energy emitted by each feature may still be sufficiently detected by image capturing system 130. Thus, target tracking computing device 210 may adequately track the object of interest based on the intensity information generated by each feature associated with the object of interest. As noted above, target tracking computing device 210 may track the object of interest based on any type of feature data. However, for ease of discussion, the following discussion is presented in light of implementing intensity information although other types of feature data may also be implemented to adequately track the object of interest.

Rather than computing the feature data generated by the features associated with the object of interest, target tracking computing device 210 may generate histograms from the feature data to decrease the processing required to analyze the feature data to adequately track the object of interest. A histogram is a graphical representation of the distribution of data that estimates the probability distribution of data that is continuously variable. For example, target tracking computing device 210 may generate histograms from the intensity information that represents the level of electromagnetic energy emitted by the particular feature as the particular feature moves throughout the field of view.

Rather than directly computing the intensity information to track the particular feature, target tracking computing device 210 may generate an intensity distribution histogram that represents the intensity level of the particular feature. The intensity distribution histogram provides a graphical representation of the probability distribution of the likelihood that specific intensity information obtained by target tracking computing device 210 is associated with the particular feature of the object of interest. Target tracking computing device 210 then determines that the intensity information with the highest likelihood of being associated with the particular feature of the object of interest is actually associated with the particular feature and then tracks the particular feature based on such intensity information.

Target tracking computing device 210 may compare the intensity distribution histograms generated from the intensity information extracted from the features of the object of interest to previously-generated intensity distribution histograms stored in feature data database 290. The user may identify the object of interest that is to be tracked and program target tracking computing device 210 with the features of the object of interest that are to have the intensity information extracted. Target tracking computing device 210 may initially extract the intensity information for the features from initial images captured by image capturing system 130 where the images depict the object of interest without any skews, rotations, scaling changes, non-uniformities, and/or any other artifacts. Target tracking computing device 210 may then generate the initial intensity distribution histograms from the intensity information associated with each specified feature and store the initial intensity distribution histograms in feature data database 290.

As the object of interest then maneuvers throughout the field of view of image capturing system 130, target tracking computing device 210 may extract the intensity information associated with each specified feature. Target tracking computing device 210 may then generate intensity distribution histograms extracted from the intensity information for each feature and compare the intensity distribution histograms with the previously-generated initial intensity distribution histograms stored in feature data database 290. Target tracking computing device 210 may then compare the intensity distribution histograms with the previously-generated intensity distribution histograms stored in feature data database 290.

The likelihood that the extracted intensity information has actually been extracted from the particular features of the object of interest is increased when the intensity distribution histograms are within the threshold of the previously-generated intensity distribution histograms stored in feature data database 290. Based on this increased likelihood, target tracking computing device 210 may associate the intensity distribution histograms with the specified features of the object of interest and continue to track the object of interest based on such intensity information.

The likelihood that the extracted intensity information has actually been extracted from the particular features of the object of interest is decreased when the intensity distribution histograms are outside the threshold of the previously-generated intensity distribution histograms stored in feature data database 290. Based on this decreased likelihood, target tracking computing device 210 may refrain from associating the intensity distribution histograms with the specified features of the object of interest and no longer continue to track the object based on such intensity information.

In an embodiment, target tracking computing device 210 may store each intensity distribution histogram that is generated in feature data database 290 so that the intensity distribution histograms stored in feature data database 290 accumulate as target tracking computing device 210 tracks the object of interest. Target tracking computing device 210 may then compare each newly-generated intensity distribution histogram to each of the previously-generated intensity distribution histogram stored in feature data database 290 to determine whether the newly extracted intensity information is associated with the particular features of the object of interest. As a result, slight variations in the intensity information associated with the particular features of the object of interest from the intensity information initially extracted may be accounted for by target tracking computing device 210. Thus, target tracking computing device 210 may continue to track the object of interest despite the slight variations in the intensity information rather than discontinuing the tracking of the object of interest.

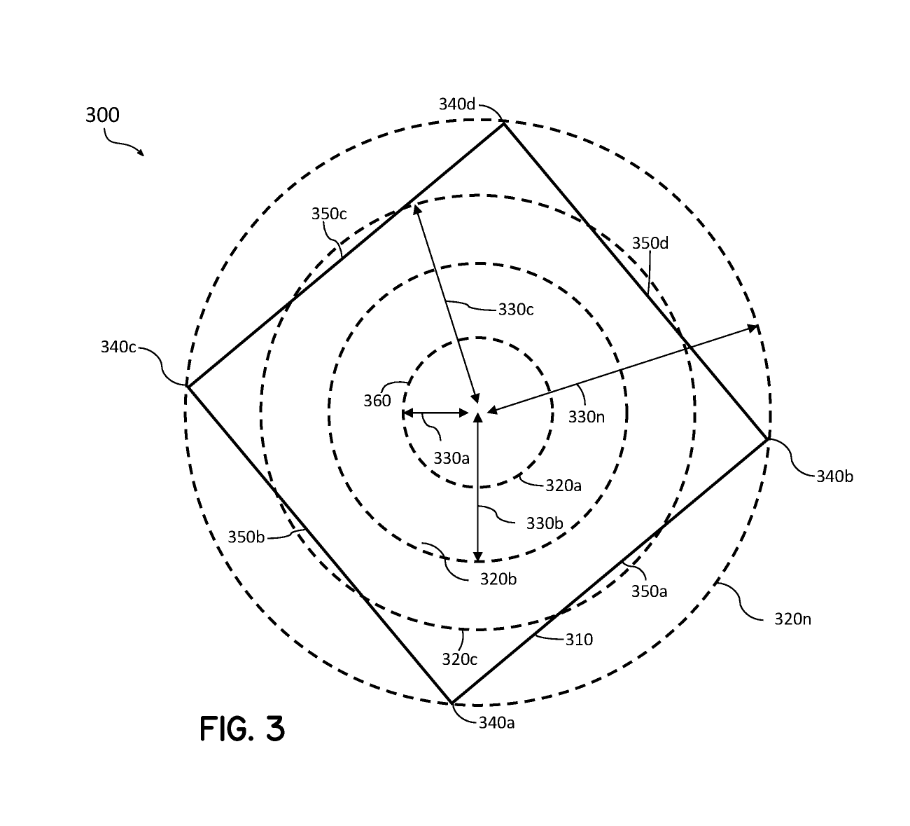

Target tracking computing device 210 may extract the intensity information from each of the features of the object of interest by overlaying a plurality of ringlets that are concentrically positioned on the object of interest. FIG. 3 depicts a detailed view of an exemplary ringlet configuration 300 for tracking an object of interest based on features associated with the object of interest. Ringlet configuration 300 includes an object of interest 310 and a plurality of ringlets 320(a-n) where n is an integer equal to or greater than two. Each of the ringlets 320(a-n) includes a corresponding radius 330(a-n) where n is an integer that corresponds to the quantity of ringlets 320(a-n).

Target tracking computing device 210 may overlay ringlets 320(a-n) on object of interest 310 so that ringlets 320(a-n) are concentrically positioned on object of interest 310. Ringlets 320(a-n) are concentrically positioned so that ringlet 320a with the smallest radius 330a is positioned over a center feature of object of interest 310. Then ringlet 320b with radius 330b that is greater than radius 330a but less than radius 330c of ringlet 320c is positioned so that ringlet 320b encircles ringlet 320a. Then ringlet 320c with radius 330c that is greater than radius 330a and radius 330b but less than radius 330n of ringlet 320n is positioned so that ringlet 320c encircles both ringlet 320a and ringlet 320b. Then ringlet 320n with radius 330n that is greater than radius 330a, radius 330b, and radius 330c is positioned so that ringlet 320n encircles ringlet 320a, ringlet 320b, and ringlet 320c and so on so that each of the ringlets 320(a-n) are concentrically positioned on object of interest 310.

Target tracking computing device 210 may position each ringlet 320(a-n) so that each ringlet 320(a-n) encompasses different features associated with object of interest 310. Each ringlet 320(a-n) may be positioned to encompass different features in a concentric fashion so that ringlets 320a and 320b encompass features associated with a center portion of object of interest 310 and ringlet 320n encompasses features associated with the edges of object of interest 310. For example, object of interest 310 may be a vehicle. Ringlet 320n may encompass features of object of interest 310 that include corners 340(a-d) of object of interest 310. Ringlet 320c may encompass features of object of interest 310 that include a front bumper 350c, a rear bumper 350a, driver side doors 350b, and passenger side doors 350d of object of interest 310. Ringlets 320a and 320b may encompass a center portion 360 of the roof of object of interest 310.

Each ringlet 320(a-n) then extracts intensity information associated with the different features of object of interest 310 from the pixels included in the field of view of image capturing system 130 that are encompassed by each ringlet 320(a-n). For example, ringlet 320a may extract intensity information from pixels encompassed by radius 330a. Ringlet 320b may extract intensity information from pixels encompassed by radius 330b but refrain from extracting intensity information from pixels encompassed by radius 330a. Ringlet 320c may extract intensity information from pixels encompassed by radius 330c but refrain from extracting intensity information from pixels encompassed by radius 330a and radius 330b. Ringlet 320n may extract intensity information from pixels encompassed by radius 330n but refrain from extracting intensity information from pixels encompassed by radius 330a, radius 330b, and radius 330c.

The positioning of ringlets 320a and 320b so that ringlets 320a and 320b encompass center portion 360 of object of interest 310 provides substantial rotational invariance in the tracking of object of interest 310 by target tracking computing device 210. As noted above, ringlets 320a and 320b may extract intensity information from pixels that are associated with center portion 360 of object of interest 310. As image capturing system 130 tracks object of interest 310 as object of interest 310 maneuvers throughout the field of view, the rotation of center portion 360 of object of interest 310 relative to the field of view of image capturing system 130 is minimal. As a result, the pixels associated with center portion 360 of object of interest 310 continue to be associated with center portion 360 as image capturing system 130 adjusts the field of view to track object of interest 310. Thus, the likelihood of a drastic shift in the pixels associated with center portion 360 due to the rotation of object of interest 310 is low.

The low likelihood of a drastic shift in pixels associated with center portion 360 due to the rotation of object of interest 310 provides rotational invariance to the tracking of object of interest 310 by target tracking computing device 210. Ringlets 320a and 320b extract intensity information from the pixels associated with center portion 360 of object of interest 310 as object of interest 310 maneuvers throughout the field of view of image capturing system 130.

Because the pixels associated with center portion 360 are substantially the same despite object of interest 310 rotating, the intensity information extracted by ringlets 320a and 320b that are associated with center portion 360 also has an increased likelihood of being substantially similar as object of interest 310 rotates. The intensity distribution histograms then generated by target tracking computing device 210 for the intensity information associated with center portion 360 as the object of interest 310 rotates are also substantially similar. Due to the similarity in the intensity distribution histograms, the intensity distribution histograms may be determined to be within the specified threshold when target tracking computing device 210 compares the intensity distribution histograms to previously-generated intensity distribution histograms stored in feature data database 290. As a result, target tracking computing device 210 associates the intensity distribution histograms with object of interest 310 and continues to track object of interest 310 as object of interest 310 rotates resulting in rotational invariance in the tracking of object of interest 310.

The tracking of object of interest 310 based on the rotational invariance prevents target tracking computing device 210 from no longer tracking object of interest 310 when object of interest 310 changes directions. As noted above, the rotational invariance results in ringlets 320a and 320b extracting substantially similar intensity information as object of interest 310 rotates so that target tracking computing device 210 continues to track object of interest 310 despite changing directions.

For example, object of interest 310 may disappear from the field of view of image capturing system 130 when object of interest 310 enters a tunnel. Object of interest 310 may then reappear in the field of view of image capturing system 130 by departing the tunnel and is traveling in a different direction than when object of interest 310 entered the tunnel. The intensity information extracted from center portion 360 of object of interest 310 by ringlets 320a and 320b when object of interest 310 departs the tunnel is substantially similar to the intensity information extracted by ringlets 320a and 320b when object of interest 310 entered the tunnel. Rather than failing to track object of interest 310 as object of interest 310 departs the tunnel in a direction different than when object of interest 310 entered the tunnel, target tracking computing device 210 continues to associate the similar intensity information captured by ringlets 320a and 320b with object of interest 310. As a result, target tracking computing device 210 continues to track object of interest 310 despite the change in directions resulting in rotational invariance in tracking object of interest 310.

As noted above, image capturing system 130 may have a wide field of view with low resolution so that the features of object of interest 310 are less defined. The intensity information extracted by ringlets 320a and 320b provide rotational invariance in the tracking of object of interest 310 due to the high likelihood that the intensity information may be substantially similar as object of interest 310 rotates. However, the overlaying of ringlets 320a and 320b to encompass center portion 360 of object of interest 310 may not provide features that significantly differentiate from other objects to prevent target tracking computing device 210 from mistakenly tracking other objects. For example, center portion 360 of the vehicle may not be a distinguishing characteristic from other vehicles.

The rotational invariance provided by the overlaying of ringlets 320a and 320b to encompass center portion 360 of object of interest 310 may be supplemented with additional ringlets 320c and 320n that are overlaid to encompass other features that are unique to object of interest 310. However, simply overlaying ringlet 320n to encompass corners 340(a-d) of object of interest 310 hinders target tracking computing device 210 to continue to track object of interest 310 when object of interest 310 rotates. As noted above, ringlet 320n may have an increased likelihood of encompassing different pixels when object of interest 310 rotates that may result in intensity information that changes when object of interest 310 rotates. Thus, a multiple ringlet configuration may provide rotational invariance coupled with feature distinction particularly in low resolution imagery so that object of interest 310 may be adequately tracked by target tracking computing device 210.

For example, ringlet 320n may encompass features of object of interest 310 that include corners 340(a-d) of object of interest 310. The corners 340(a-d) may be features that are unique to object of interest 310 and differentiate significantly from other objects so that the intensity information extracted by ringlet 320n from corners 340(a-d) of object of interest 310 also differentiate significantly from the intensity information extracted from corners of other objects. The resulting intensity distribution histograms associated with corners 340(a-d) of object of interest 310 also differentiate significantly from intensity distribution histograms associated with corners of other objects. The differentiating intensity information extracted from corners 340(a-d) from corners with other objects coupled with the rotational invariance of the intensity information extracted from center portion 360 enables target tracking computing device 210 to adequately track object of interest 310.

The quantity of ringlets 320(a-n) may be selected based on the complexity of object of interest 310 as well as the processing power of target tracking computing device 210. A sufficient quantity of ringlets 320(a-n) may be selected so that differentiating features of object of interest 310 may be adequately encompassed by ringlets 320(a-n) while maintaining rotational invariance in tracking object of interest 310. Increasing the quantity of ringlets 320(a-n) may also increase the accuracy in tracking object of interest 310. However, each additional ringlet 320(a-n) incorporated into the tracking of object of interest 310 increases the quantity of intensity information that is extracted from object of interest 310 which increases the processing power required by target tracking computing device 210 to track object of interest 310. Increasing the quantity of ringlets 320(a-n) that exceeds the processing capabilities of target tracking computing device 210 may hinder the performance of target tracking computing device 210 in tracking object of interest 310. The quantity of ringlets 320(a-n) may be any integer greater than or equal to two to sufficiently track object of interest 310 without exceeding the processing capabilities of target tracking computing device 210.

After the quantity of ringlets 320(a-n) is selected, target tracking computing device 210 may determine the size of object of interest 310. Target tracking computing device 210 may then determine radius 330n of the largest ringlet 320n so that the ringlet 320n encompasses the outer edges of object of interest 310. Target tracking computing device 210 may then determine the remaining radii 330(a-c) of each remaining ringlet 320(a-c) based on the size of object of interest 310 so that object of interest 310 is adequately encompassed by each ringlet 320(a-n).

As the distance between image capturing system 130 and object of interest 310 increases, the size of object of interest 310 relative to image capturing system 130 decreases so target tracking computing device 210 decreases radii 330(a-n) accordingly so that the scale of each ringlet 320(a-n) relative to object of interest 310 remains substantially the same. As the distance between image capturing system 130 and object of interest 310 decreases, the size of object of interest 310 relative to image capturing system 130 increases so target tracking computing device 210 increases radii 330(a-n) accordingly so that the scale of each ringlet 320(a-n) relative to object of interest 310 remains substantially the same.

Target tracking computing device 210 weights the intensity information extracted by each ringlet 320(a-n) based on the features of object of interest 310 encompassed by each ringlet 320(a-n). As noted above, intensity information generated by each feature of object of interest 310 increases the accuracy in tracking object of interest 310 particularly in a low resolution field of view provided by image capturing system 130 while maintaining rotational invariance.

Rather than implementing a binary binning scheme where features encompassed by a single ringlet are included in the tracking of object of interest 310 and features falling outside of the single ringlet are excluded, the weighting of intensity information enables substantially all of the intensity information extracted by multiple ringlets to be incorporated. Providing a greater weight to intensity information that has a higher likelihood of being rotationally invariant increases the likelihood that target tracking computing device 210 continues to track object of interest 310 despite object of interest 310 rotating. Also, providing a lesser weight to intensity information that has a lower likelihood of being rotationally invariant while continuing to include such intensity information increases the likelihood of target tracking computing device 210 to differentiate object of interest 310 from other objects.

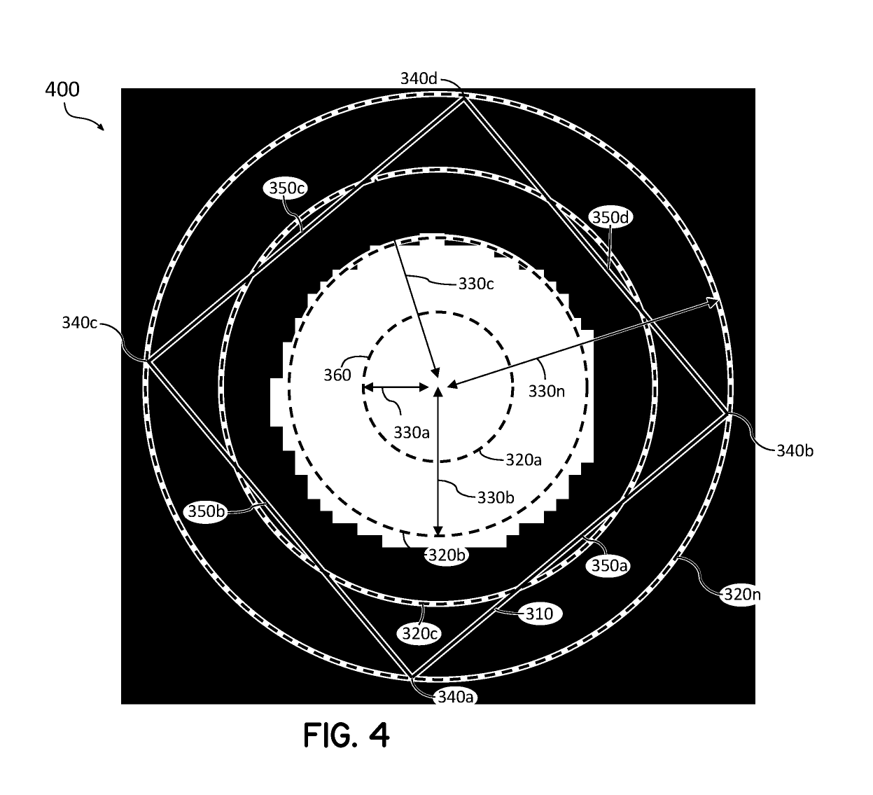

Target tracking computing device 210 may incorporate a Gaussian ringlet intensity distribution function to weight the intensity information extracted by each ringlet 320(a-n). FIG. 4 depicts a detailed view of an exemplary Gaussian configuration 400 generated from ringlets 320(a-n) in tracking an object of interest 310 based on features associated with the object of interest 310. Target tracking computing device 210 weights the intensity information extracted by each ringlet 320(a-n) with a Gaussian distribution where the weights applied to each ringlet 320(a-n) range from 1 to 0. Implementing the Gaussian distribution function enables target tracking computing device 210 to weight the intensity information extracted from ringlets 320a and 320b that have the highest likelihood of being rotationally invariant with a “1” and are depicted with the most intense shading in Gaussian configuration 400. The Gaussian distribution function then weights each remaining ringlet 320(c-n) so that the weight assigned to each ringlet 320(c-n) decreases as the likelihood of the intensity information extracted by each ringlet 320(c-n) being rotationally invariant decreases. The intensity of the shading associated with the intensity information captured by ringlets 320(c-n) progressively dim as the likelihood of the intensity information being rotationally invariant decreases.

For example, the Gaussian distribution function may weight the intensity information extracted by ringlet 320b with a “1” based on the likelihood of the intensity information extracted by ringlet 320b of being rotationally invariant being greater than ringlet 320c and is depicted with the brightest shading in Gaussian configuration 400. The Gaussian distribution function may weight the intensity information extracted by ringlet 320c with a “0.5” based on the likelihood of the intensity information extracted by ringlet 320c of being rotationally invariant being greater than ringlet 320n but less than ringlets 320a and 320b. The shading associated with the intensity information extracted by ringlet 320c may be less intense than the shadings associated with ringlet 320a and 320b but more intense than ringlet 320n. The Gaussian distribution function may weight the intensity information extracted by ringlet 320n with a “0.3” based on the likelihood of the intensity information extracted by ringlet 320n of being rotationally invariant being greater than intensity information extracted outside of ringlet 320n but less than ringlets 320a, 320b, and 320c. The shading associated with the intensity information extracted by ringlet 320n may be less intense than the shadings associated with ringlets 320a, 320b, and 320c but more intense than shadings outside of ringlet 320n. The Gaussian distribution function may weight any intensity information extracted from outside ringlet 320n with a “0” and ignores such intensity information because the likelihood of such intensity information being associated with object of interest 310 is low.

Target tracking computing device 210 may then incorporate the weights generated from the Gaussian ringlet intensity distribution function for each ringlet 320(a-n) into the intensity distribution histograms generated from the intensity information extracted by each ringlet 320(a-n). Target tracking computing device 210 may then generate a representative vector from each of the intensity distribution histograms generated for each ringlet 320(a-n). The representative vector represents the overall weighted intensity information associated with object of interest 310. Target tracking computing device 210 may then compare the representative vector to the previously-generated representative vectors stored in feature data database 290. Target tracking computing device 210 may then determine an Earth Mover's Distance between the generated representative vector and the stored representative vectors. The Earth Mover's Distance is the measure of the distance between the intensity probability distributions depicted by the generated representative vector and the stored representative vector.

The likelihood that the generated representative vector is associated with object of interest 310 is high when the Earth Mover's Distance is within the specified threshold. Thus, target tracking computing device 210 may continue to track object of interest 310 when the calculated Earth Mover's Distance is within the specified threshold. The likelihood that the generated representative vector is associated with object of interest 310 is low when the Earth Mover's Distance is outside the specified threshold. Thus, target tracking computing device 210 may no longer track object of interest 310 when the calculated Earth Mover's Distance is outside the specified threshold.

Target tracking computing device 210 may determine the sizes of ringlets 320(a-n) based on equal distance or equal area. Ringlets 320(a-n) that are equal distance have radii 330(a-n) that are scaled relative to each other. For example, radius 330a may be a distance of 5 pixels. Radius 330b may be a distance of 10 pixels. Radius 330c may be a distance of 15 pixels and radius 330n may be a distance of 20 pixels. Target tracking computing device 210 may assume that ringlets 320(a-n) that are equal distance extract intensity information that is weighted less as the corresponding radii 330(a-n) increase. With such an increase in radii 330(a-n), the quantity of pixels included in each ringlet 320(a-n) increases with the increase in radii 330(a-n) so that ringlet 320a includes the least amount of pixels and ringlet 320n includes the greatest amount of pixels. Target tracking computing device 210 may also assume the intensity information extracted from the least amount of pixels in ringlet 320a is given the greatest weight and so on.

Ringlets 320(a-n) that are equal area have radii 330(a-n) selected so that each ringlet 320(a-n) includes an equal amount of area that is not included by other ringlets. For example, radius 330b may be selected so that the area of pixels included in ringlet 320b may be substantially the same as the area of pixels included in ringlet 320a. The area of pixels included in ringlet 320b may be the area of pixels encompassed by ringlet 320b but not encompassed by ringlet 320a. Radius 330c may be selected so that the area of pixels included in ringlet 320c may be substantially the same as the area of pixels included in ringlets 320a and 320b. The area of pixels included in ringlet 320c may be the area of pixels encompassed by ringlet 320c but not encompassed by ringlets 320a and 320b. Radius 330n may be selected so that the area of pixels included in ringlet 320n is substantially the same as the area of pixels included in ringlets 320a, 320b, and 320c. The area of pixels included in ringlet 320n may be the area of pixels encompassed by ringlet 320n but not encompassed by ringlets 320a, 320b, and 320c.

Target tracking computing device 210 may implement equal area ringlets 320(a-n) to normalize the intensity information extracted by each ringlet 320(a-n). After the weighting has been applied to the intensity information extracted by each ringlet 320(a-n) by the Gaussian ringlet intensity distribution function, the equal area of ringlets 320(a-n) normalizes the intensity information so that each ringlet 320(a-n) includes a substantially equal number of pixels. After the weighting applied by the Gaussian distribution function, additional weighting is prevented due to ringlets including a greater amount of pixels as compared to other ringlets. The greater amount of pixels included in a ringlet results in a greater amount of intensity information extracted by that ringlet as compared to other ringlets so that ringlet has an increase in unnecessary weight. Equal area ringlets normalize the intensity information extracted by each ringlet 320(a-n) by having each ringlet 320(a-n) include a substantially equal number of pixels.

Creating an intensity distribution histogram from extracted intensity information by a ringlet that is weighted with the Gaussian ringlet intensity distribution function beings with the definition of a Gaussian function as shown in Equation 1:

$$f ( x ) = a {e}^{- \frac{{( x - b )}^{2}}{2 {c}^{2}}} \qquad ( 1 )$$

where a is a constant, b is the center of the distribution and c is the standard deviation. To create Gaussian rings, the Gaussian function is wrapped around a specific radius R and with a standard deviation σ and then derives Equation 2 using polar coordinates.

$$f ( R ) = a {e}^{- \frac{{( R - {R}_{cen} )}^{2}}{2 {σ}^{2}}} \qquad ( 2 )$$

where R is location of pixel, R_{cen} is the location of the center of the sub-image, and σ is the standard deviation. To define the ringlets with a certain radius,

R(x,y)=\sqrt{x²+y²} (3)

where x and y are the Cartesian coordinates of the pixel. When using the radius equation, the shifts in the center of the Gaussian circle and the surrounding ringlets are accounted for. In Equation 4, the center coordinates are removed.

R(x,y)=\sqrt{(x−x_{cen}²)+(y−y_{cen}²)} (4)

where x_{cen} and y_{cen} are the Cartesian coordinates of the center. To develop the Gaussian ringlets, the mean and standard deviation is defined based on the type of histogram ringlets, either equal distance or equal area. Given the edges of radii of the ringlets, the mean (Mᵢ) and standard deviation (SDᵢ) can be as follows,

$$\begin{matrix}{M}_{i} = \frac{{R}_{i} + {R}_{i - 1}}{2} & ( 5 ) \\ {SD}_{i} = \frac{{R}_{i} - {R}_{i - 2}}{2} & ( 6 )\end{matrix}$$

where Rᵢ and Rᵢ₋₁ are the edge radii of the ringlets. Depending on the amount of overlap between ringlets, the standard deviation may be modified to improve the recognition. The usual width for the Gaussian ringlets may be one standard deviation to align with the ring edges, thus deriving Equation 7 and Equation 8.

$$\begin{matrix}{f}_{1} ( x , y ) = a {e}^{- \frac{( \sqrt{{{( x - {x}_{cen} )}^{2} + {( y - {y}_{cen} )}^{2} )}^{2}}}{\frac{1}{x} {( {R}_{i} - {R}_{i - 1} )}^{2}}} & ( 7 ) \\ {f}_{i} ( x , y ) = a {e}^{- \frac{{( \sqrt{{( x - {x}_{cen} )}^{2} + ( y - {{y}_{cen}}^{2} )} - \frac{1}{2} ( {R}_{i} + {R}_{i - 1} ) )}^{2}}{\frac{1}{2} {( {R}_{i} - {R}_{i - 1} )}^{2}}} & ( 8 )\end{matrix}$$

where f₁ is the Gaussian center and fᵢ are the subsequent Gaussian ringlets.

Ring normalization may be done by creating masks and dividing the histograms by the area as shown in Equation 9.

Nᵢ=Σᵥ₌₀^{v}Hᵢ(v) (9)

where Nᵢ is the normalization for mask i, V is the number of bin values, and Hᵢ is the histogram for i. By dividing the histograms by the normalization factors, each ringlet mask may have the same weighting during the match distance computation.

Weighting of the ringlets may be created to enhance specific portions of the object of interest that are of more importance than other regions. For example, the center of the object of interest may be considered the most important because the center of the object of interest is the portion that is most likely to be rotationally invariant. As the ringlets go progressively outward, the ringlets may be considered to have more noise due to the scene, but still have a considerable amount of features necessary for identifying the object of interest. Equation 10 provides a weighting scheme.

Hᵢ=wᵢ*Hᵢ (10)

where Hᵢ is the new weighted histogram and wᵢ is the weight associated with the histogram. Equation 11 presents a linear weighting scheme.

wᵢ=(I−i)+1 (11)

where I is the number of ringlets in the masks and i is the ringlet number (going from inner to outer rings). Once the distributions have been obtained by both the reference image and the detected image, the match distance can be calculated using Earth Mover's Distance.

### Method

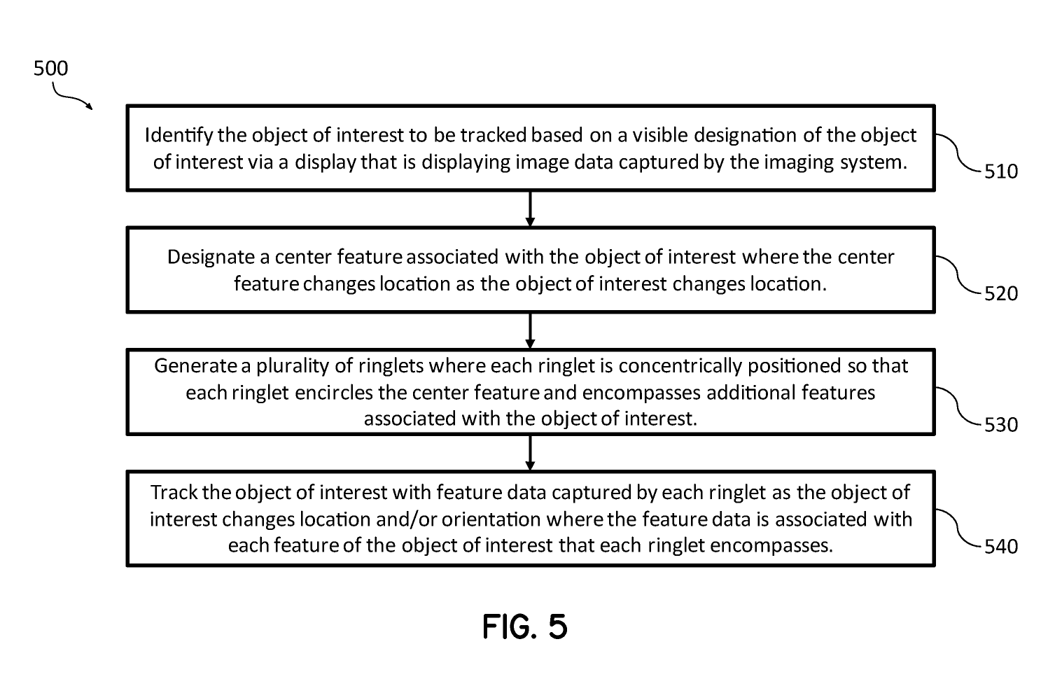

FIG. 5 is a flowchart showing an example method 500 for identifying and tracking an object of interest from an image capturing system based on a plurality of features associated with the object of interest. As shown in FIG. 5, method 500 begins at stage 510 when the object of interest to be tracked is identified based on a visible designation of the object of interest from image data captured by the image capturing system. For example, as shown in FIG. 2 and FIG. 3, object of interest 310 that is to be tracked is identified based on a visible designation of object of interest 310 from image data captured by image capturing system 130. Stage 510 can be performed by, for example, processor 270.

At stage 520, a center feature associated with the object of interest is designated. The center feature changes location as the object of interest changes location. For example, as shown in FIG. 2 and FIG. 3, a center portion 360 associated with object of interest 310 is designated. Center portion 360 changes location as object of interest 310 changes location. Stage 520 can be performed by, for example, processor 270.

At stage 530, a plurality of ringlets is generated. Each ringlet is concentrically positioned so that each ringlet encircles the center feature and encompasses additional features associated with the object of interest. For example, as shown in FIG. 2 and FIG. 3, a plurality of ringlets 320(a-n) is generated. Each ringlet 320(a-n) is concentrically positioned so that each ringlet 320(a-n) encircles center portion 360 and encompasses front bumper 350c, rear bumper 350a, driver side doors 350b, passenger side doors 350, and corners 340(a-d) associated with object of interest 310. Stage 530 can be performed by, for example, processor 270.

At stage 540, the object of interest is tracked with feature data captured by each ringlet as the object of interest changes location and/or orientation. The feature data is associated with each feature of the object of interest that each ringlet encompasses. For example, as shown in FIG. 2 and FIG. 3, object of interest 310 is tracked with intensity information captured by each ringlet 320(a-n) as object of interest 310 changes location and/or orientation. The intensity information may be associated with center portion 360, front bumper 350c, rear bumper 350a, driver side doors 350b, passenger side doors 350, and corners 340(a-d) that each ringlet 320(a-n) encompasses. Stage 540 can be performed by, for example, processor 270.

Embodiments can work with software, hardware, and/or operating system implementations other than those described herein. Any software, hardware, and operating system implementations suitable for performing the functions described herein can be used. Embodiments are applicable to both a client and to a server or a combination of both.

### Example Computer System

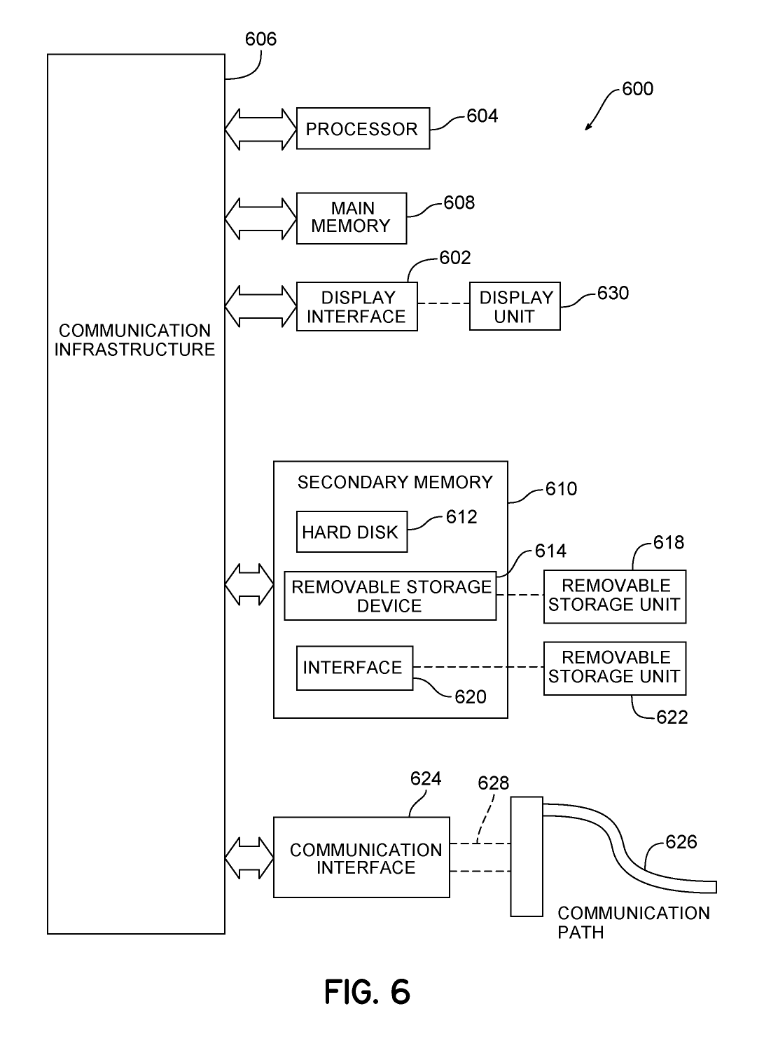

FIG. 6 illustrates an example computer system 600 in which embodiments of the present invention, or portions thereof, may be implemented as computer-readable code. For example, target tracking computing device 210 may be implemented on computer system 600 using hardware, software, firmware, tangible computer readable media having instructions stored thereon, or a combination thereof and may be implemented in one or more computer systems or other processing system.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various embodiments of the invention are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, a computing device having at least one processor, such as processor 604, where the processor may be a single processor, a plurality of processors, a processor in a multi-core/multiprocessor system, such system operating alone, or in a cluster of computing devices operating in a cluster or server farm. Processor 604 is connected to a communication infrastructure 606, for example, a bus, message queue, network, or multi-core message-passing scheme.

Computer system 600 also includes a main memory 608, for example, random access memory (RAM), and may also include a secondary memory 610. Secondary memory 610 may include, for example, a hard disk drive 612, removable storage drive 614. Removable storage drive 614 may include a floppy disk drive, a magnetic tape drive, an optical disk drive, a flash memory, or the like. The removable storage drive 614 reads and/or writes to a removable storage unit 618 in a well-known manner. Removable storage unit 618 may include a floppy disk, magnetic tape, optical disk, etc. which is read by and written to by removable storage drive 614. As will be appreciated by persons skilled in the relevant art, removable storage unit 618 includes a computer readable storage medium having stored therein computer software and/or data.

In alternative implementations, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as EPROM or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interfaces 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626.

In this document, the terms “computer program storage medium” and “computer usable storage medium” are used to generally refer to storage media such as removable storage unit 618, removable storage unit 622, and a hard disk installed in hard disk drive 612. Computer program storage medium and computer usable storage medium may also refer to memories, such as main memory 608 and secondary memory 610, which may be semiconductor memories (e.g., DRAMS, etc.).

Computer programs (also called computer control logic) are stored in main memory 608 and/or secondary memory 610. Computer programs may also be received via communications interface 624. Such computer programs, when executed, enable computer system 600 to implement embodiments as discussed herein. In particular, the computer programs, when executed, enable processor 604 to implement the processes of embodiments of the invention, such as the stages in the method illustrated by flowchart 500 of FIG. 5 discussed above. Accordingly, such computer programs represent controllers of the computer system 600. When an embodiment is implemented using software, the software may be stored in a computer program product and loaded into computer system 600 using removable storage drive 614, interface 620, and hard disk drive 612, or communications interface 624.

The Brief Summary and Abstract sections may set forth one or more but not all example embodiments and thus are not intended to limit the scope of embodiments of the invention and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of embodiments of the invention that others can, by applying knowledge within the skill of the art, readily modify and/or adapt for various applications such specific embodiments, without undue experimentation, without departing from the general concept of embodiments of the invention. Therefore, such adaptation and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the invention should not be limited by any of the above-described example embodiments, but should be defined only in accordance with the following claims and their equivalents.

What is claimed is:

1. A system for identifying and tracking an object of interest from an image capturing system based on a plurality of features associated with the object of interest, comprising:
at least one processor; and
a memory coupled with the processor, the memory including instructions that, when executed by the processor cause the processor to:
identify the object of interest to be tracked based on a visible designation of the object of interest from image data captured by the image capturing system,
designate a center feature associated with the object of interest, wherein the center feature changes location as the object of interest changes location,
generate a plurality of ringlets, wherein each ringlet is concentrically positioned so that each ringlet encircles the center feature and encompasses additional features associated with the object of interest,
track the object of interest with feature data extracted by each ringlet as the object of interest changes location and/or orientation, wherein the feature data is associated with each feature of the object of interest that each ringlet encompasses.

2. The system of claim 1, wherein the feature data includes intensity information that represents a level of electromagnetic energy emitted by each feature of the object of interest that each ringlet encompasses.

3. The system of claim 1, wherein the instructions that when executed by the processor, further cause the processor to designate the center feature associated with the object of interest that is substantially rotationally invariant, wherein a center feature orientation of the center feature remains substantially unchanged relative to a change in the orientation of the object of interest.

4. The system of claim 1, wherein the instructions that when executed by the processor, further cause the processor to generate a histogram for each ringlet based on the feature data extracted by each ringlet, wherein each histogram depicts a distribution of the feature data as the feature data for each feature changes over a period of time.

5. The system of claim 4, wherein the instructions that when executed by the processor, further cause the processor to:
maintain a center feature orientation of a center ringlet that encompasses the center feature so that the orientation is unchanged relative to a change in the orientation of the object of interest so that the center ringlet is substantially rotationally invariant; and
maintain a center histogram for the center ringlet so that a distribution of center feature data for the center feature is unchanged relative to changes in the orientation of the object of interest based on center feature data extracted by the center ringlet remaining unchanged relative to changes in the orientation of the object of interest.

6. The system of claim 1, wherein the instructions that when executed by the processor, further cause the processor to:
determine whether a specified pixel included in the image data is encompassed by a specified ringlet and is not encompassed by each ringlet with a ringlet diameter that is less than the ringlet diameter associated with the specified ringlet; and
associate the specified pixel with the specified ringlet when the specified pixel is encompassed within the specified ringlet and is not encompassed by each ringlet with the ringlet diameter that is less than the ringlet diameter associated with the specified ringlet.

7. The system of claim 6, wherein the instructions that when executed by the processor, further cause the processor to assign a weight to each pixel, wherein the weight assigned to each pixel decreases as the ringlet diameter of each ringlet that corresponds to each pixel increases.

8. The system of claim 7, wherein the instructions that when executed by the processor, further cause the processor to generate the weight for each pixel based on a Gaussian function, wherein each weight assigned to each pixel decreases in a sequential fashion as the ringlet diameter of each ringlet that corresponds to each pixel increases.

9. The system of claim 7, wherein the instructions that when executed by the processor, further cause the processor to:
generate a representative vector incorporating each weight assigned to each pixel, wherein each pixel represents a portion of the object of interest depicted via the image data;
compare the representative vector with previously-generated representative vectors, wherein the previously-generated representative vectors were generated when the object of interest was positioned at previous locations that differ from a present location of the object of interest; and
confirm the representative vector is associated with the object of interest when the representative vector is within a threshold of the previously-generated representative vectors.

10. The system of claim 9, wherein the instructions that when executed by the processor, further cause the processor to:
calculate a probability distance for the representative vector, wherein the probability distance depicts a difference in the feature data associated with each ringlet;
compare the probability distance associated with the representative vector and the probability distance associated with each previously-generated representative vector; and
confirm the representative vector is associated with the object of interest when the probability distance associated with the representative vector is within the threshold of each probability distance associated with each previously-generated representative vector.

11. A method for identifying and tracking an object of interest from an image capturing system based on a plurality of features associated with the object of interest, comprising:
identifying, by a processor, the object of interest to be tracked based on a visible designation of the object of interest from image data captured by the image capturing system;
designating, by the processor, a center feature associated with the object of interest, wherein the center feature changes location as the object of interest changes location;
generating, by the processor, a plurality of ringlets, wherein each ringlet is concentrically positioned so that each ringlet encircles the center feature and encompasses additional features associated with the object of interest; and
tracking, by the processor, the object of interest with feature data extracted by each ringlet as the object of interest changes location and/or orientation, wherein the feature data is associated with each feature of the object of interest that each ringlet encompasses.

12. The method of claim 11, wherein the feature data includes intensity information that represents a level of electromagnetic energy emitted by the each feature of the object of interest that each ringlet encompasses.

13. The method of claim 11, wherein the designating comprises:
designating the center feature associated with the object of interest that is substantially rotationally invariant, wherein a center feature orientation of the center feature remains substantially unchanged relative to a change in the orientation of the object of interest.

14. The method of claim 11, further comprising:
generating a histogram for each ringlet based on the feature data extracted by each ringlet, wherein each histogram depicts a distribution of the feature data as the feature data for each feature changes over a period of time.

15. The method of claim 14, further comprising:
maintaining a center feature orientation of a center ringlet that encompasses the center feature so that the orientation is unchanged relative to a change in the orientation of the object of interest so that the center ringlet is substantially rotationally invariant; and
maintaining a center histogram for the center ringlet so that a distribution of center feature data for the center feature is unchanged relative to changes in the orientation of the object of interest based on center feature data extracted by the center ringlet remaining unchanged relative to changes in the orientation of the object of interest.

16. The method of claim 11, further comprising:
determining whether a specified pixel included in the image data is encompassed by a specified ringlet and is not encompassed by each ringlet with a ringlet diameter that is less than the ringlet diameter associated with the specified ringlet; and
associating the specified pixel with the specified ringlet when the specified pixel is encompassed within the specified ringlet and is not encompassed by each ringlet with the ringlet diameter that is less than the ringlet diameter associated with the specified ringlet.

17. The method of claim 16, further comprising:
assigning a weight to each pixel, wherein the weight assigned to each pixel decreases as the ringlet diameter of each ringlet that corresponds to each pixel increases.

18. The method of claim 17, further comprising
generating the weight for each pixel based on a Gaussian function, wherein each weight assigned to each pixel decreases in a sequential fashion as the ringlet diameter of each ringlet that corresponds to each pixel increases.

19. The method of claim 17, further comprising:
generating a representative vector incorporating each weight assigned to each pixel, wherein each pixel represents a portion of the object of interest depicted via the image data;
comparing the representative vector with previously-generated representative vectors, wherein the previously-generated representative vectors were generated when the object of interest was positioned at previous locations that differ from a present location of the object of interest; and
confirming the representative vector is associated with the object of interest when the representative vector is within a threshold of the previously-generated representative vectors.

20. The method of claim 19, further comprising:
calculating a probability distance for the representative vector, wherein the probability distance depicts a difference in the feature data associated with each ringlet;
comparing the probability distance associated with the representative vector and the probability distance associated with each previously-generated representative vector; and
confirming the representative vector is associated with the object of interest when the probability distance associated with the representative vector is within the threshold of each probability distance associated with each previously-generated representative vector.

21. A non-transitory computer readable storage medium encoded with a computer program, the program comprising instructions that when executed by one or more processors cause the one or more processors to perform operations comprising:
identifying the object of interest to be tracked based on a visible designation of the object of interest from image data captured by the image capturing system;
designating a center feature associated with the object of interest, wherein the center feature changes location as the object of interest changes location;
generating a plurality of ringlets, wherein each ringlet is concentrically positioned so that each ringlet encircles the center feature and encompasses additional features associated with the object of interest; and
tracking the object of interest with feature data extracted by each ringlet as the object of interest changes location and/or orientation, wherein the feature data is associated with each feature of the object of interest that each ringlet encompasses.
